(19) United States
(12) Patent Application Publication
(10) Pub. No.: US 2009/0304980 A1
(43) Pub. Date: Dec. 10, 2009

(54) Lightweight masonry bonding compound

(76) Inventor: Chan Wiryakusuma, New South Wales (AU)

Correspondence Address: Chan Wiryakusuma, 16 Earls Ave, Riverwood, 2210, AU

(21) Appl. No.: 11/921,376

(22) PCT Filed: Feb. 20, 2006
(86) PCT No.: PCT/AU2006/000210

§ 371 Date: Aug. 20, 2007

(30) Foreign Application Priority Data
Feb. 23, 2006 (AU) 2005900814

(51) Int. Cl. B32B 13/00; B32B 1/04

(52) U.S. Cl. 428/70; 106/638; 428/220

(57) ABSTRACT

A lightweight masonry compound (027) including the wrapping or protector cover (024, 025), said compound in a band form with particular dimensions in thickness, width and length; ready to use on site without the need of any equipment or tools; preferably having bonding strength and compressive strength equivalent or better than standard conventional mortar or dry premix or wet premix; capable of bonding masonry products.

The present invention relates to prefabricated building hardware or building components and, more particularly, to performed masonry bonding fabrication system.

### BACKGROUND

The masonry bonding compounds that have been used in building sector for hundreds of years are known or called mortar and formed as wet mixture of cementing materials, sand and water. The mixture is made on site prior to the application of the compound to the masonry blocks that need to be bonded together. The mixture is aired dry till harden. The bonding capability of the mixture is develop from the wet stage of the mixture through and up to the dry stage. If the mixture got to dry on its own, then this dry compound has no bonding capability anymore, therefore this wet mixture is not store-able for future use to bond two or more masonry together. Already in the market, are a number of products that offering dry pre-mix, which still need to be re-mixed with some water to turn it into a wet stage of mixture which then developing the bonding capability of the dry pre-mix. Also, available in the market are wet pre-mix bonding products in paste form. This wet premix bonding product are quite expensive for brick wall application. Those products above need some tools and equipments to apply to the masonry that need to be bonded together.

Applying of this wet bonding mixture to the masonry that need to be bonded together, might result some dripping, dropping or spraying of the wet mixture to the surface of others building components or to other surface of the masonry themself. These dripping, dropping and spraying of the mixture will dry and become stains or defects to those surfaces of those building component which then need to be cleaned.

Known in the art yet an article nor topics related to this invention at the current time of the search.

It is an object of the present invention to address or ameliorate some, if not all, of the above disadvantages.

### BRIEF DESCRIPTION OF INVENTION

Accordingly, in a first broad form of the invention, there is provided a lightweight masonry bonding compound in a band form at a particular size in term of thickness, width and length; said have the wrapping or protector cover that peal-able; said having colour to match the colour of the masonry; said are store-able; said develop bonding capability once said applied to the objects; said has the equivalent compression strength as the conventional one or the dry pre-mix one.

Preferably, said is pre-manufacture product that is ready to be used or apply on site to any masonry product with out the need of mixer equipment nor added other material

Preferably, said content of bonding or cementing substance, colour substance and other chemical substances.

Preferably, said is in firm but soft form that will not melt under normal summer temperature.

Preferably, said will not deform noticeably in shape when its subjected to the self-weight load of the masonries.

Preferably, said has standard bonding or cementing characteristics that require to bond two or more masonries together

Preferably, said will harden just by air curing only

Preferably, said when its dry will have the compressive strength equivalent to the standard masonry compressive strength

Preferably, said thickness is equivalent to the normal thickness of the conventional mortar of a standard laid brick wall

Preferably, said is wrapped or covered with protector that peal -able and preventing said being harden.

Preferably, said is storable under normal room temperature for a reasonable period of time with out drying up

### BRIEF DESCRIPTION OF DRAWING

Embodiment of the present invention will now be described with reference to the accompanying drawings wherein:

FIG. 1 is a perspective or 3 dimensional view of a preferred embodiment of a prefabricated lightweight masonry bonding compound according to the invention.

FIG. 2 shows a plan view, front view, end view and sectioned view of the preferred embodiment of the present invention FIG. 1 FIG. 3 shows the application of the preferred embodiment of a prefabricated lightweight masonry bonding compound in sequence of application steps in building up a brick wall of ordinary brick blocks.

FIG. 4 shows the application of the preferred embodiment of a prefabricated lightweight masonry bonding compound in joining up vertically Lightweight Simulated Brick Panels to an intended height

FIG. 5 shows the application of the preferred embodiment of a prefabricated lightweight masonry bonding compound in joining Lightweight Simulated Brick Panels to an intended length

FIG. 6 shows the application of the preferred embodiment of a prefabricated lightweight masonry bonding compound in joining Lightweight Simulated Brick Panels to perform a 90 degree corner wall.

### DETAILED DESCRIPTION OF PREFERRED EMBODIMENTS

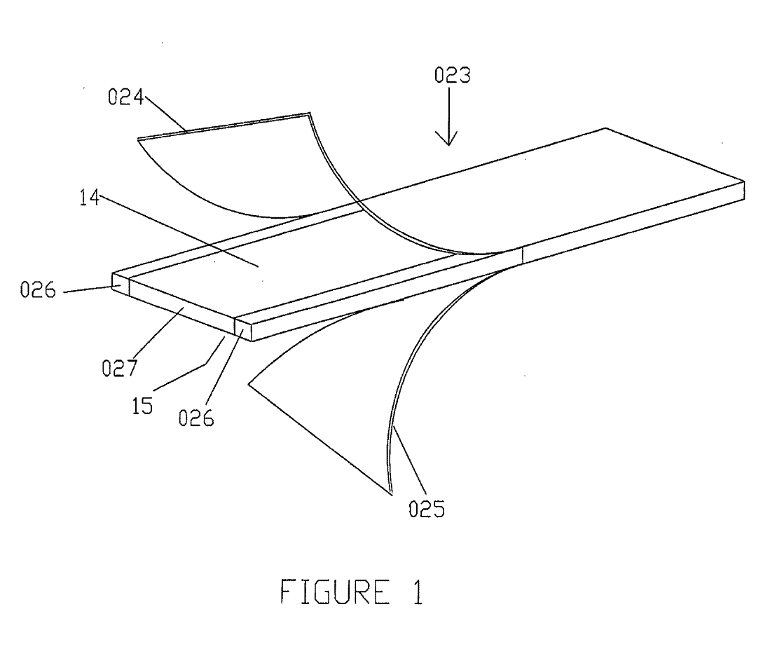

With reference to FIG. 1, the lightweight masonry bonding compound 027 forms a bonding element of masonry blocks in a band form with rectangular section in a particular width, height and length.

The width “W” and the height “H” are preferably equal to the equivalent depth and thickness dimension of conventional mortar of laid conventional brick wall.

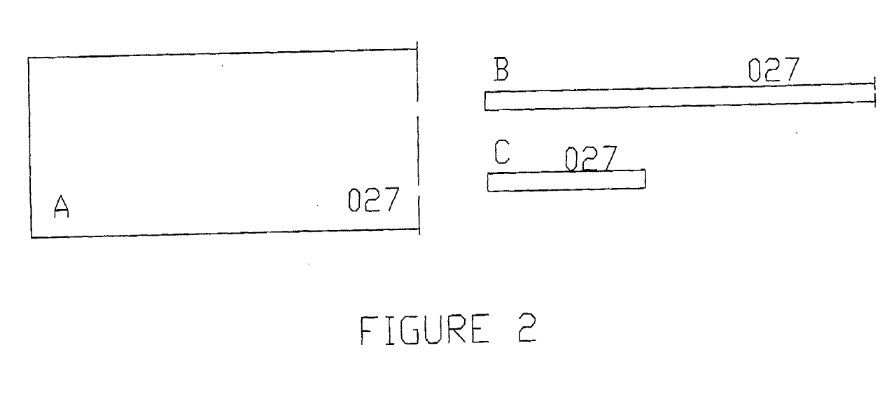

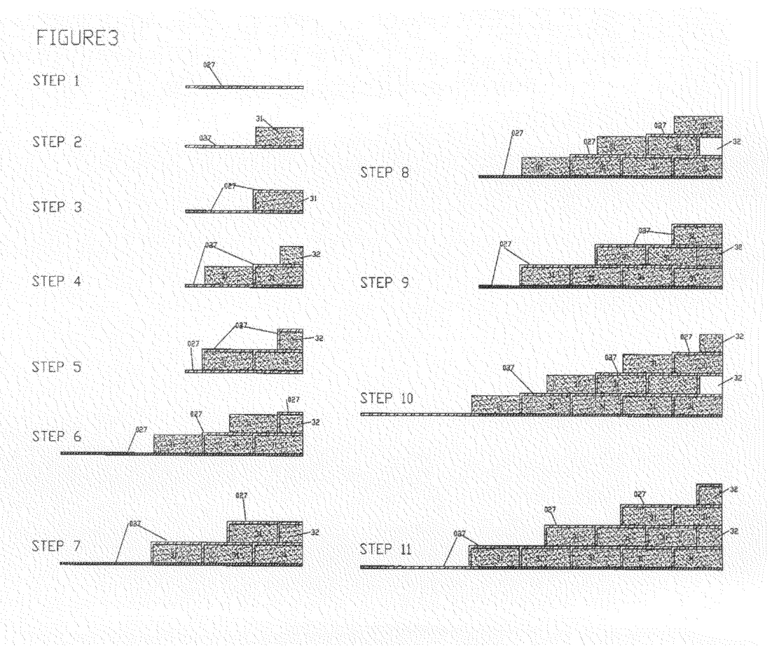

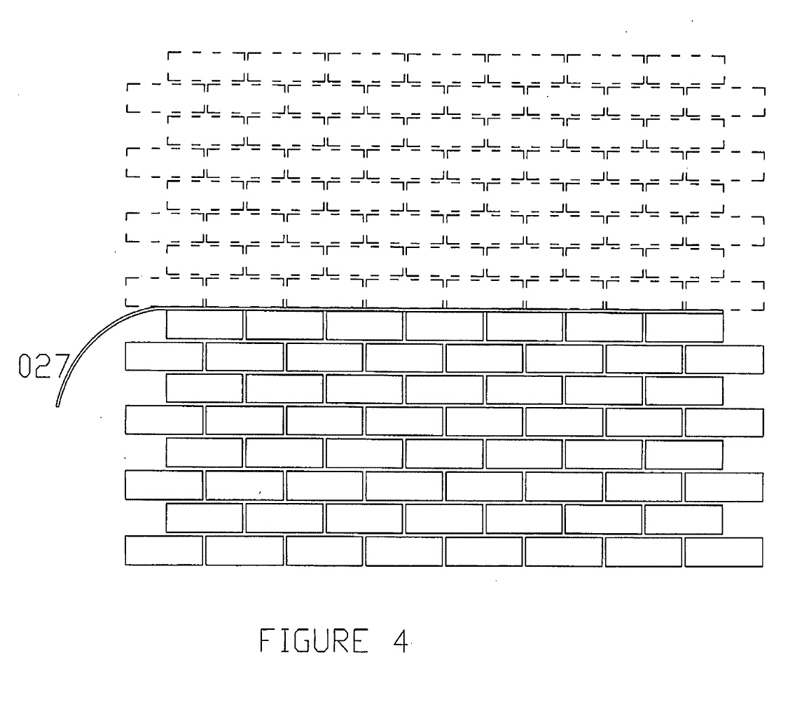

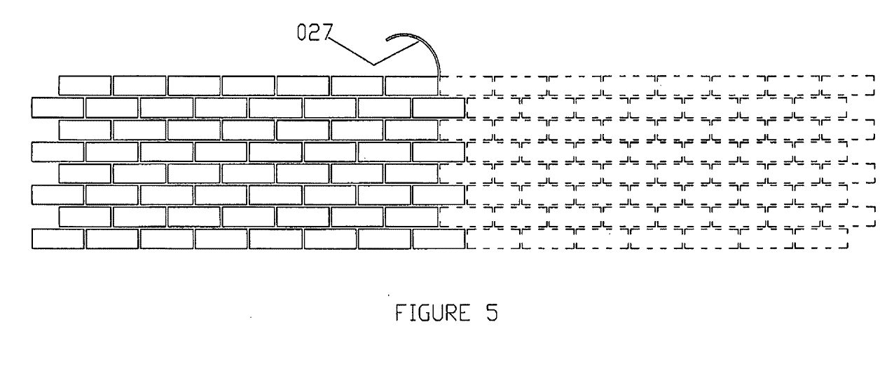

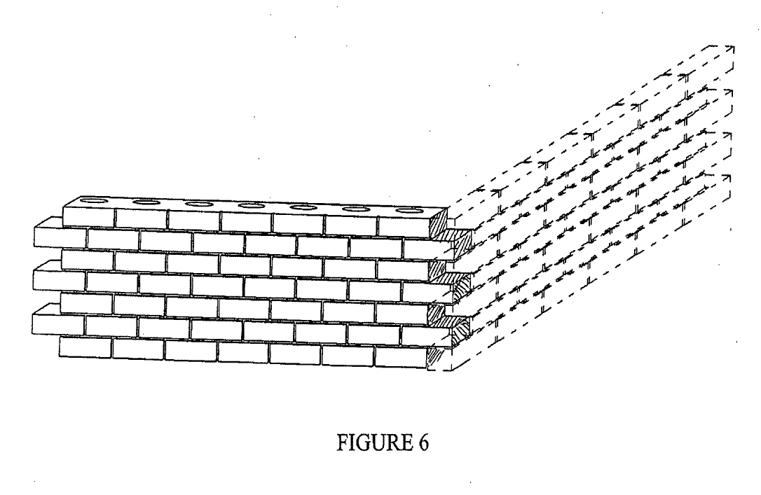

With reference to FIG. 2 to 5, the present invention lightweight masonry bonding compound 027 bonds two or more laid conventional bricks performing a conventional brick wall pattern.

### Manufacture

Preferably, the invention products are produced at a manufacturing facility prior to delivering to building project site.

The manufacturing process preferably is a mixing process of cementing/bonding substance, colour substance and other substances and follow with forming/shaping process of the product including the air curing process and then all packaging process.

### Application

The application of this present invention lightweight masonry bonding compound is significantly simplified when compared to the application of conventional mortar. With reference to FIGS. 2 to 5, follows are preferably the description of the application steps of the present invention:
1. Peel off one side of the cover and place the product to the surface of the masonry or brick.
2. Press the product firmly to ensure the bonding
3. Peel off the top cover
4. Place the masonry/brick on top of it and firmly press it down
5. For a short period of time, the product will hardening
6. The masonry/brick than will bonded to each other

The package of the compound as described above could be done differently depend on the outcome of the trial and testing of the invention. The application process will be more apparent from the illustration drawings.

1. The lightweight masonry bonding compound is a compound of some substances and a colour substance

2. The substances are probably chemical substances which will produce bonding characteristic which are mixed with another chemical substance that will make the product lightweight

3. The lightweight masonry bonding compound is a pre-fabricated product

4. The lightweight masonry bonding compound is a ready to use product

5. The lightweight masonry bonding compound is no skill require for application

6. The lightweight masonry bonding compound is in firm but soft form that will not melt under normal summer temperature.

7. The lightweight masonry bonding compound will not deform noticeably in shape and dimension at the early stage when its subjected to the self weight load of the masonry

8. The lightweight masonry bonding compound has standard bonding or cementing characteristics require to bond masonry products together

9. The lightweight masonry bonding compound will harden just by air curing only

10. The lightweight masonry bonding compound bind any masonry products together

11. The lightweight masonry bonding compound when its dry have the compressive strength equivalent or better to standard masonry compressive strength

12. The lightweight masonry bonding compound have thickness which is equivalent to the thickness dimension of standard mortar of a standard laid brick wall

13. The lightweight masonry bonding compound is store-able under normal room temperature for a reasonable period of time with out drying up
